(19) United States
(12) Patent Application Publication
(10) Pub. No.: US 2024/0415328 A1
(43) Pub. Date: Dec. 19, 2024

(54) GRIDDLE AND COOKWARE SET FOR FRYING

(71) Applicant: Haohong Electric Technology (Hubei) Co., Ltd., Huanggang (CN)

(72) Inventor: Min WANG, Huanggang (CN)

(73) Assignee: Haohong Electric Technology (Hubei) Co., Ltd., Huanggang (CN)

(21) Appl. No.: 18/461,174

(22) Filed: Sep. 5, 2023

(30) Foreign Application Priority Data
Jun. 16, 2023 (CN) 202321557404.1

(51) Int. Cl. A47J 37/06

(52) U.S. Cl. CPC A47J 37/067

(57) ABSTRACT

Disclosed are a griddle and a cookware set for frying. The griddle includes a main body and a plurality of height-adjusting assemblies. The main body is provided with a recess for containing foods. Each of the height-adjusting assemblies includes an adjusting bolt and an adjusting piece, the adjusting bolt and the adjusting piece are in threaded connection. A plurality of the adjusting bolts are provided at intervals on a side of the main body away from an opening of the recess, and the plurality of the adjusting bolts are configured for being engaged with the plurality of installing holes in a plugging manner, and the adjusting piece is configured for being abutted against the installing hole and adjusting a distance between the main body and the grill.

### CROSS-REFERENCE TO RELATED APPLICATIONS

This application claims priority to Chinese Patent Application No. 202321557404.1, filed on Jun. 16, 2023, the entire contents of which are incorporated herein by reference.

### TECHNICAL FIELD

The present application relates to the technical field of cookware, in particular to a griddle and a cookware set for frying.

### BACKGROUND

A griddle is usually used with a grill. When the grill is used on uneven ground, it will cause the grill to tilt, and therefore the griddle on the grill will also tilt. Meanwhile, the griddle will wobble as the placement is not stable during use, which is not easy for the user to use and brings poor user experience.

### SUMMARY

The main purpose of the present application is to provide a griddle, aiming to improve the practicability of the griddle.

In order to achieve the purpose above, the present application provides a griddle for a grill, the grill has a plurality of installing holes provided at intervals, and the griddle includes a main body and a plurality of height-adjusting assemblies. The main body is provided with a recess for containing foods. Each of the height-adjusting assemblies includes an adjusting bolt and an adjusting piece, the adjusting bolt and the adjusting piece are in threaded connection. A plurality of the adjusting bolts are provided at intervals on a side of the main body away from an opening of the recess, and the plurality of the adjusting bolts are configured for being engaged with the plurality of installing holes in a plugging manner, and the adjusting piece is configured for being abutted against the installing hole and adjusting a distance between the main body and the grill.

In an embodiment, the adjusting piece includes an adjusting nut and a threaded sleeve, the adjusting nut and the adjusting bolt are in threaded connection. The adjusting nut is provided with an abutting portion, the abutting portion is provided at a bottom of the adjusting nut and sleeved on the adjusting bolt. The threaded sleeve is sleeved on and in threaded connection to the adjusting bolt. One end of the threaded sleeve is abutted against the main body, and the other end of the threaded sleeve is abutted against one end of the adjusting nut away from the abutting portion.

In an embodiment, the griddle further includes a baffle assembly, the baffle assembly includes a first baffle, a second baffle and two third baffles. The two third baffles are provided opposite to each other. The first baffle and the second baffle are provided opposite to each other. The first baffle, the second baffle and the two third baffles are provided along a peripheral direction of the main body, and are configured to enclose the main body to form the recess. A height of the first baffle is H1, a height of the second baffle is H2, and H1>H2. The third baffle is provided with a transitional portion, one end of the transitional portion is connected to the third baffle, and the other end of the transitional portion is connected to an end part of the second baffle. A sectional area of the transitional portion decreases gradually along a direction close to the second baffle.

In an embodiment, the griddle further includes an oil trough provided at an end of a bottom wall of the recess close to the first baffle and communicating with the recess, and a wall of the oil trough close to the recess is configured to be sloped.

In an embodiment, an oil drainage hole is provided on the oil trough, a wall of the oil drainage hole is extended in a height direction of the main body and is protruded from and provided on a side of the oil trough away from an opening of the oil trough.

In an embodiment, the griddle further includes a reinforcing assembly. The reinforcing assembly includes two first reinforcing rods and a plurality of second reinforcing rods provided on a side of the main body away from the recess. The two first reinforcing rods are arranged at intervals along a length direction of the main body, and the plurality of second reinforcing rods are provided between and connected to the two first reinforcing rods.

In an embodiment, the reinforcing assembly further includes a plurality of third reinforcing rods provided on the side of the main body away from the recess. The plurality of third reinforcing rods are arranged at intervals along a width direction of the main body, and the plurality of third reinforcing rods are provided between and connected to the two first reinforcing rods.

In an embodiment, the material of the main body is sequentially stacked by 304 stainless steel, aluminum and 430 stainless steel.

In an embodiment, a plurality of etched grooves are evenly provided on a side of the main body facing the recess, and an inner concave surface of each of the etched grooves is provided with non-stick coating.

A cookware set for frying is further introduced in this application. The cookware set for frying includes a griddle and a grill. The griddle includes a main body and a plurality of height-adjusting assemblies. The main body is provided with a recess for containing foods. Each of the plurality of height-adjusting assemblies includes an adjusting bolt and an adjusting piece, the adjusting bolt and the adjusting piece are in threaded connection. A plurality of the adjusting bolts are provided at intervals on a side of the main body opposite to an opening of the recess, and the plurality of the adjusting bolts are configured for being engaged with the plurality of installing holes in a plugging manner, and the adjusting piece is configured for being abutted against the installing hole and adjusting a distance between the main body and the grill. The grill is provided with a plurality of installing holes arranged at intervals.

When the grill is used on uneven ground, it will cause the grill to tilt, and the griddle on the grill will also tilt. However, in the technical solutions of the present application, the adjusting bolts of the griddle can be plugged into the installing holes of the grill, and the adjusting piece is abutted against the installing hole. As a result, the griddle can be stably placed on the grill by adjusting the adjusting piece to adjust a distance between the main body and the grill, which prevents the griddle from wobbling and affecting the users' experience, and improves the practicability of the griddle.

### BRIEF DESCRIPTION OF THE DRAWINGS

In order to more clearly illustrate the technical solutions in the embodiments of the present application or in the prior art, drawings that are needed to illustrate the embodiments and the prior art are simply introduced below. Obviously, drawings introduced below are just some of the embodiments in the present application. For those of ordinary skill in the art, other figures may be further obtained without creative efforts according to the structures shown in drawings below.

FIG. 1 is an exploded structural schematic view of a griddle according to an embodiment of the present application.

FIG. 2 is a bottom view of a griddle according to an embodiment of the present application.

FIG. 3 is a schematic view of the material of a griddle according to an embodiment of the present application.

The realization of the purpose, the functional feature, and the advantage of present application will be further illustrated referring to the drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all the embodiments of the present application. All other embodiments obtained by persons skilled in the art based on the embodiments of the present application without creative efforts shall fall within the scope of the present application.

It should be noted that all the directional indications (such as up, down, left, right, front, rear, etc.) in the embodiments of the present application are only used to explain the relative positional relationship, movement, or the like of the components in a certain posture (as shown in the drawings). If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

A griddle is usually used with a grill, when the grill is used on uneven ground, it will cause the grill to tilt, and therefore the griddle on the grill will also tilt, and the griddle will wobble as the placement is not stable during use, which is not easy for the user to use and brings poor user experience.

To solve the above problem, a griddle is introduced in the present application, aiming to improve the practicability of the griddle.

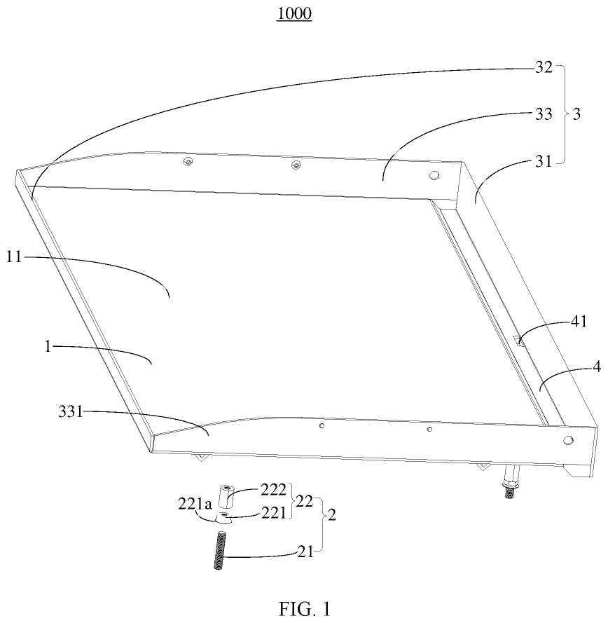

Please refer to FIGS. 1 to 3, a griddle 1000 is introduced in an embodiment of the present application. The griddle 1000 is used for a grill, and the grill has a plurality of installing holes provided at intervals. The griddle 1000 includes a main body 1 and a plurality of height-adjusting assemblies 2. The main body 1 is provided with a recess 11 for containing foods. Each of the height-adjusting assemblies 2 includes an adjusting bolt 21 and an adjusting piece 22, the adjusting bolt 21 and the adjusting piece 22 are in threaded connection. A plurality of the adjusting bolts 21 are provided at intervals on a side of the main body 1 away from an opening of the recess 11, and the plurality of the adjusting bolts 21 are configured for being engaged with the plurality of installing holes in a plugging manner, and the adjusting piece 22 is configured for being abutted against the installing hole and adjusting a distance between the main body 1 and the grill.

When the grill is used on uneven ground, it will cause the grill to tilt, and the griddle 1000 on the grill will also tilt. However, in this embodiment, the adjusting bolts 21 of the griddle 1000 can be plugged into the installing holes of the grill, and the adjusting piece 22 is abutted against the installing hole. As a result, the griddle 1000 can be stably placed on the grill by adjusting the adjusting piece 22 to adjust a distance between the main body 1 and the grill, which prevents the griddle 1000 from wobbling and affecting the users' experience, and improves the practicability of the griddle 1000.

Please refer to FIG. 1, in an embodiment the present application, the adjusting piece 22 includes an adjusting nut 221 and a threaded sleeve 222, the adjusting nut 221 and the adjusting bolt 21 are in threaded connection. The adjusting nut 221 is provided with an abutting portion 221a, the abutting portion 221a is provided at a bottom of the adjusting nut 221 and sleeved on the adjusting bolt 21. The threaded sleeve 222 is sleeved on and in threaded connection to the adjusting bolt 21. One end of the threaded sleeve 222 is abutted against the main body 1, and the other end of the threaded sleeve 222 is abutted against one end of the adjusting nut 221 away from the abutting portion 221a. By providing the threaded sleeve 222, the distance between the griddle 1000 and the grill is increased, and prevents that when the adjusting bolts 21 are completely plugged into the installing holes, the distance between the griddle 1000 and the grill is too small to facilitate users to adjust the adjusting nut 221. Since the adjusting nut 221 and the adjusting bolt 21 are in threaded connection, the distance between the griddle 1000 and the grill can be increased or decreased by turning the adjusting nut 221 clockwise or counterclockwise, and the structure is simple and easy to operate.

Please refer to FIG. 1, in order to prevent foods on the main body 1 from dropping, in an embodiment of the present application, the griddle 1000 includes a baffle assembly 3, the baffle assembly 3 includes a first baffle 31, a second baffle 32 and two third baffles 33. The two third baffles 33 are provided opposite to each other. The first baffle 31 and the second baffle 32 are provided opposite to each other. The first baffle 31, the second baffle 32 and the two third baffles 33 are provided along a peripheral direction of the main body 1 and are configured to enclose the main body 1 to form the recess 11. A height of the first baffle 31 is H1, a height of the second baffle 32 is H2, and H1>H2. The third baffle 33 is provided with a transitional portion 331, one end of the transitional portion 331 is connected to the third baffle 33, and the other end of the transitional portion 331 is connected to an end part of the second baffle 32. A sectional area of the transitional portion 331 decreases gradually along a direction close to the second baffle 32.

When using the griddle 1000, the baffle assembly 3 can effectively prevent foods on the main body 1 from dropping, which improves the practicability of the griddle 1000. The griddle 1000 can be used not only for cooking dishes, but also for roasting skewers. When using the griddle 1000, the user stands on a side facing the second baffle 32, and then the user can put the gripper ends of the skewers on the second baffle 32. Since the height of the second baffle 32 isn't too high, food materials near the gripper ends and those far from the gripper ends won't receive unbalanced heat.

Please refer to FIG. 1, in an embodiment of the present application, the griddle 1000 further includes an oil trough 4 provided at an end of a bottom wall of the recess 11 close to the first baffle 31 and communicating with the recess 11, and a wall of the oil trough 4 close to the recess 11 is configured to be sloped. To avoid a problem that oil on the griddle 1000 is too much and affects cooking dishes, excess or waste oil will flow past the wall of the oil trough 4 and into the oil trough 4. The wall of the oil trough 4 close to the recess 11 is configured to be sloped, and excess or waste oil can flow more smoothly into the oil trough 4 and be collected.

In order to drain out excess or waste oil from the oil trough 4, please refer to FIG. 1, in an embodiment of the present application, an oil drainage hole 41 is provided on the oil trough 4, a wall of the oil drainage hole 41 is extended in a height direction of the main body 1 and is protruded from and provided on a side of the oil trough 4 away from an opening of the oil trough 4. Excess or waste oil flow past the wall of the oil trough 4 and into the oil trough 4, and then is drained out through the oil drainage hole 41. An oil collector may be provided under the oil drainage hole 41 to collect the excess or waste oil to prevent it from spilling onto the ground and polluting the environment.

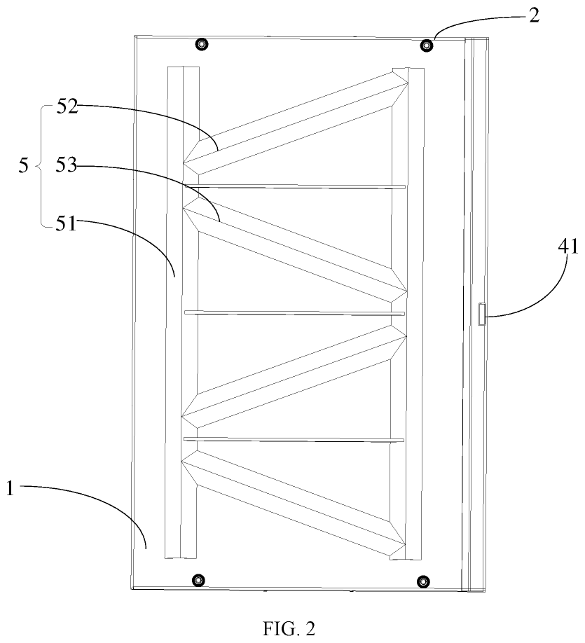

In order to improve the strength of the griddle 1000, please refer to FIG. 2, in an embodiment of the present application, the griddle 1000 further includes a reinforcing assembly 5. The reinforcing assembly 5 includes two first reinforcing rods 51 and a plurality of second reinforcing rods 52 provided on a side of the main body 1 away from the recess 11. The two first reinforcing rods 51 are arranged at intervals along a length direction of the main body 1, and the plurality of second reinforcing rods 52 are provided between and connected to the two first reinforcing rods 51. By providing the reinforcing assembly 5, the compressive strength of the griddle 1000 is improved, thereby prolonging the service life of the griddle 1000.

Further, please refer to FIG. 2, in an embodiment of the present application, the reinforcing assembly 5 further includes a plurality of third reinforcing rods 53 provided on the side of the main body 1 away from the recess 11. The plurality of third reinforcing rods 53 are arranged at intervals along a width direction of the main body 1, and the plurality of third reinforcing rods 53 are provided between and connected to the two first reinforcing rods 51. By providing the plurality of third reinforcing rods 53, the compressive strength of the griddle 1000 is further improved.

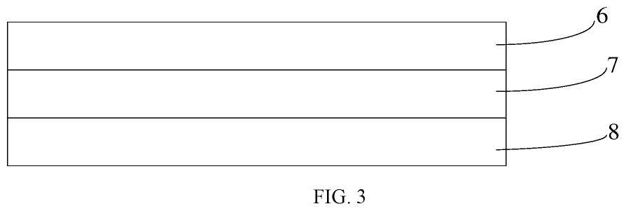

In order to improve the durability of the griddle 1000, please refer to FIG. 3, in an embodiment of the present application, the material of the main body 1 is sequentially stacked by 304 stainless steel 6, aluminum 7 and 430 stainless steel 8. The above mentioned material enables the griddle 1000 to achieve effects of being non-stick, durable and in fast temperature rising. What can be understood is that the material of the griddle 1000 may be iron, and the processing procedures of the griddle 1000 are sequentially iron molding, enameling, sandblasting and spraying non-stick coating, so as to achieve effects of being non-stick, easy to clean and durable.

In order to achieve the effect of being non-stick for the griddle 1000, in an embodiment of the present application, a plurality of etched grooves are evenly provided on a side of the main body 1 facing the recess 11, and an inner concave surface of each of the etched grooves is provided with non-stick coating. The non-stick coating may be anodized aluminum coating or the coating made of polytetrafluoroethylene, there is no limit in this embodiment. By providing the plurality of etched grooves, steel shovels are prevented from touching the non-stick coating in the etched grooves when stir frying, and the service life of the griddle 1000 is prolonged.

A cookware set for frying is further introduced in the present application. The cookware set includes a griddle 1000 and a grill, and the structures of the griddle 1000 can be referred to the above embodiments. Since the cookware set has adopted technical solutions mentioned in the above embodiments, it has technical effects brought by the technical solutions mentioned in the above embodiments, and there is no need to repeat them here.

The cookware set for frying includes a griddle 1000 and a grill. The griddle 1000 includes a main body 1 and a plurality of height-adjusting assemblies 2. The main body 1 is provided with a recess 11 for containing foods. Each of the height-adjusting assemblies 2 includes an adjusting bolt 21 and an adjusting piece 22, the adjusting bolt 21 and the adjusting piece 22 are in threaded connection. A plurality of the adjusting bolts 21 are provided at intervals on a side of the main body 1 away from an opening of the recess 11, and the plurality of the adjusting bolts 21 are configured for being engaged with the plurality of installing holes in a plugging manner, and the adjusting piece 22 is configured for being abutted against the installing hole and adjusting a distance between the main body 1 and the grill. The grill is provided with a plurality of installing holes arranged at intervals.

When the grill is used on uneven ground, it will cause the grill to tilt, and the griddle 1000 on the grill will also tilt. However, in the technical solutions of this embodiment, the adjusting bolts 21 of the griddle 1000 can be plugged into the installing holes of the grill, and the adjusting piece 22 is abutted against the installing hole. As a result, the griddle 1000 can be stably placed on the grill by adjusting the adjusting piece 22 to adjust a distance between the main body 1 and the grill, which prevents the griddle 1000 from wobbling and affecting the users' experience, and improves the practicability of the griddle 1000.

The above-mentioned embodiments are only some embodiments of the present application, and are not intended to limit the scope of the present application. Any equivalent structure conversion made with reference to the description and the accompanying drawings of the present application, directly or indirectly applied in other related technical fields, should all fall in the scope of the present application.

What is claimed is:

1. A griddle for a grill, wherein the grill has a plurality of installing holes provided at intervals, the griddle comprises:
a main body provided with a recess for containing foods, and
a plurality of height-adjusting assemblies, wherein each of the height-adjusting assemblies comprises an adjusting bolt and an adjusting piece, and the adjusting bolt and the adjusting piece are in threaded connection; a plurality of the adjusting bolts are provided at intervals on a side of the main body away from an opening of the recess, and the plurality of the adjusting bolts are configured for being engaged with the plurality of installing holes in a plugging manner; the adjusting piece is configured for being abutted against the installing hole and adjusting a distance between the main body and the grill.

2. The griddle according to claim 1, wherein the adjusting piece comprises an adjusting nut and a threaded sleeve, the adjusting nut and the adjusting bolt are in threaded connection, the adjusting nut is provided with an abutting portion, and the abutting portion is provided at a bottom of the adjusting nut and sleeved on the adjusting bolt; and
the threaded sleeve is sleeved on and in threaded connection to the adjusting bolt, one end of the threaded sleeve is abutted against the main body, and the other end of the threaded sleeve is abutted against one end of the adjusting nut away from the abutting portion.

3. The griddle according to claim 1, wherein the griddle further comprises a baffle assembly, the baffle assembly comprises a first baffle, a second baffle and two third baffles, the two third baffles are provided opposite to each other, and the first baffle and the second baffle are provided opposite to each other; the first baffle and the second baffle and the two third baffles are provided along a peripheral direction of the main body, and are configured to enclose the main body to form the recess; and
a height of the first baffle is H1, a height of the second baffle is H2, and H1>H2; the third baffle is provided with a transitional portion, one end of the transitional portion is connected to the third baffle, and the other end of the transitional portion is connected to an end part of the second baffle; a sectional area of the transitional portion decreases gradually along a direction close to the second baffle.

4. The griddle according to claim 3, wherein the griddle further comprises an oil trough provided at an end of a bottom wall of the recess close to the first baffle and communicating with the recess; a wall of the oil trough close to the recess is configured to be sloped.

5. The griddle according to claim 4, wherein an oil drainage hole is provided on the oil trough, and a wall of the oil drainage hole is extended in a height direction of the main body and is protruded from and provided on a side of the oil trough away from an opening of the oil trough.

6. The griddle according to claim 1, wherein the griddle further comprises a reinforcing assembly, the reinforcing assembly comprises two first reinforcing rods and a plurality of second reinforcing rods provided on a side of the main body away from the recess, and the two first reinforcing rods are arranged at intervals along a length direction of the main body; the plurality of second reinforcing rods are provided between and connected to the two first reinforcing rods.

7. The griddle according to claim 6, wherein the reinforcing assembly further comprises a plurality of third reinforcing rods provided on the side of the main body away from the recess, the plurality of third reinforcing rods are arranged at intervals along a width direction of the main body, and the plurality of third reinforcing rods are provided between and connected to the two first reinforcing rods.

8. The griddle according to claim 1, wherein the material of the main body is sequentially stacked by 304 stainless steel, aluminum and 430 stainless steel.

9. The griddle according to claim 1, wherein a plurality of etched grooves are evenly provided on a side of the main body facing the recess, and an inner concave surface of each of the etched grooves is provided with non-stick coating.

10. A cookware set for frying, comprising:
the griddle according to claim 1, and
a grill provided with a plurality of installing holes arranged at intervals.
